(19) United States
(12) Patent Application Publication
(10) Pub. No.: US 2005/0149630 A1
(43) Pub. Date: Jul. 7, 2005

(54) Context sensitive transfer with active listening and active alerts

(76) Inventors: Brent Smolinski, Chapel Hill, NC (US); John Armstrong, Cambridge, MA (US); Derek Libby, Somerville, MA (US)

Correspondence Address: BAKER & MCKENZIE;PATENT DEPARTMENT, 2001 ROSS AVENUE, SUITE 2300, DALLAS, TX, 75201, US

(21) Appl. No.: 10/879,487

(22) Filed: Jun. 28, 2004

Related U.S. Application Data
(60) Provisional application No. 60/482,926, filed on Jun. 27, 2003.

(51) Int. Cl. G06F 15/16

(52) U.S. Cl. 709/227

(57) ABSTRACT

A communication system and method are configured to perform context sensitive transfers of a communication session. In one embodiment of the invention, a communication session between a calling party and a receiving party in which the communication session includes a dialog between the calling party and the receiving party is transferred from the receiving party to a third party where the dialog continues between the calling party and the third party. In another embodiment of the invention, an automated application intercepts messages of a communication session, processes the messages, and responds to what was processed in real-time while the communication session between a calling party and a receiving party continues. In a further embodiment of the invention, a communication system sends an event notification to interested parties and allows a subsequent communication session to be initiated from the delivered notification.

### RELATED APPLICATIONS INFORMATION

This application claims priority under 35 USC §119 to U.S. Provisional Application Ser. No. 60/482,926, entitled “CONTEXT SENSITIVE TRANSFER WITH ACTIVE LISTENING AND ACTIVE ALERTS,” filed on Jun. 27, 2003, which is incorporated herein by reference as though set forth in full.

### BACKGROUND

1. Field of the Inventions

The field of the invention relates generally to a system for allowing a terminal engaged in a communication session with another terminal to transfer the communication session to a third terminal, allowing communications to be intercepted, processed, and responded to, and also providing active event notifications. More specifically, the field of the invention relates to communication sessions using instant message (IM) technology, particularly in the context of a contact center.

2. Background Information

Instant messaging (IM) technology provides for instant, real-time conversations between two or more interacting terminals that are connected to a system through internal or external networks. Some examples of IM technology networks include AOL Instant Messenger, MSN Instant Messenger, Yahoo! Instant Messenger, Jabber, ICQ, and SMS. These IM networks will typically include the ability to communicate using text messaging and have the notion of presence, but may have neither.

Instant messaging technology has become very popular among users of the Internet and internal intranets. IM networks are easy to operate and provide an efficient mechanism of communication among interacting participants. IM networks are also becoming popular among corporate IM users as corporations have found IM networks particularly useful to execute transactions, interact with enterprise data and applications, and capture real-time business processes both on internal and external networks. Corporations also appreciate the ease of operability of IM networks requiring near zero learning time for employees.

Instant messaging networks are real-time in nature. Unlike e-mail systems, IM networks determine whether a terminal is logged into the IM network and able to receive a message. An IM conversation is a conversation between two or more terminals logged into an IM network that takes place in real-time. An IM conversation can also be defined as a dialog. The term “Terminal” as used herein can refer to the hardware, for example, computers or computer terminals, telecommunications equipment, etc., used by live persons to participate in, for example, an IM conversation, or to automated software and/or hardware configured for automated engagement in such a conversation or dialog.

In an IM environment, a communication session is the IM conversation or conversations between terminals in its entirety. A communication session between connections of persons to the IM network remains open from the time a person logs in to the time a person logs out. A person-to-person communication session remains open throughout the entire period terminals are logged into the IM network until one or more terminals explicitly terminates the connection.

IM dialogs have become particularly useful when communicating with a contact center. For example, a person can have an IM conversation with an automated self-help application, or “bot”, to get information on a company's product. However, the “bot” may not be programmed to answer all of the person's questions and a live agent must be contacted. In another example, a “bot” or junior employee may collect information from a caller qualifying the caller to speak to a senior employee. Thus, it may be part of the normal business process to move the caller from one agent to another at some point in the IM conversation. In another example, a person is having an IM conversation with a company representative and asks a question. However, the company representative is unable to answer the question, but recognizes that her supervisor knows the answer. Under current practices, conventional systems may be able to transfer the communication sessions to a third party, but are unable to do so efficiently. In most systems, the communication session must be terminated in order for the person to be placed in contact with the live agent or supervisor.

It is therefore sometimes desirable to efficiently transfer the communication session from a “bot” or company representative to another person or agent without terminating the existing IM conversation. Moreover, it is sometimes desirable to transfer the information gathered during the communication session, including the person's contact information and questions, to the live agent or supervisor in order to continue the conversation where the “bot” or company representative left off.

Furthermore, conventional systems do not have a process for monitoring and intercepting IM conversations to provide automated, real-time responses. It is sometimes desirable to have a system with an automated and real-time process for intercepting, processing, and responding to messages on IM networks between two or more participants, processing the intercepted messages, and responding to what was processed. Such a feature could improve the efficiency and control of various IM applications, and provide a higher quality of customer service.

Finally, IM users are often interested in being alerted when certain events occur, such as when a stock reaches a certain price, or a news story with particular keywords is found. Therefore, it is sometimes desirable to have a system that is capable of sending outgoing event notifications to interested users and allowing a follow on dialog directly from the alert.

### SUMMARY OF THE INVENTION

A communication system configured to enable a communication session between a calling party and a receiving party in which the communication session includes a dialog between the calling party and the receiving party that is transferred from the receiving party to a third party where the dialog continues between the third party and the calling party. In one aspect, either the calling party or the receiving party can initiate the transfer.

In another aspect, the communication system can be configured such that a calling party, a receiving party, and a third party can engage in a communication session in which the receiving party or the calling party can configured to initiate a transfer of the communication session by sending a transfer message to the third party. The third party responds by sending a transfer accept message. The receiving party sends a disconnect message to the calling party and the communication session continues between the calling party and the third party.

In another aspect, transferring a communication session is enabled by initiating a transfer from a receiving party by sending a transfer message to the third party and disconnecting the receiving party upon receiving a transfer accept message. The communication session then continues between the calling party and the third party.

In another aspect, a transfer protocol of a communication system is configured to disconnect and transfer the communication session between the calling party and the -receiving party. The transfer protocol includes a disconnect sequence where either the calling party or the receiving party initiates the disconnection of the other by sending a disconnect message to the other. The transfer protocol also provides a transfer sequence in which the receiving party sends a transfer message to a third party. The third party accepts the transfer and replaces the receiving party so that the communication session continues between the third party and the calling party.

In another aspect, the communication system is configured such that messages between two or more participants can be intercepted, process, and respond to by an automated application in real time. The communication session can then continue between the calling party and the receiving party.

In another aspect, a system and method for distributing outgoing interactive alerts to users of a communication session network is provided by an event generator located outside the communication system sending a message, or alert, to a communication system that further notifies all interested parties and allows a subsequent communication session to be initiated from the delivered notification.

These and other features, aspects, and embodiments of the invention are described in the section entitled “Detailed Description of the Preferred Embodiment.”

### BRIEF DESCRIPTION OF THE DRAWINGS

Preferred embodiments of the present inventions taught herein are illustrated by way of example, and not by way of limitation, in the figures of the accompanying drawings, in which:

FIG. 1 depicts a diagram illustrating an example of a communication system configured to incorporate a protocol management system between one or more calling party terminals, receiving party terminals, or a third party terminals in client server network model;

FIG. 2 depicts an exemplary embodiment of a transfer sequence of a communication session;

FIG. 3 depicts an exemplary embodiment of an interaction with a message processor in a communication session;

FIG. 4 depicts an exemplary embodiment of a connect sequence of a communication session;

FIG. 5 shows a flowchart that illustrates the connect sequence between a calling party and a receiving party;

FIG. 6 depicts an exemplary embodiment of a message sequence of a communication session;

FIG. 7 shows a flowchart that illustrates the message sequence of a communication session;

FIG. 8 depicts an exemplary embodiment of a transfer sequence of a communication session from a receiving party to an external third party.

FIG. 9 shows a flowchart that illustrates the transfer sequence of a communication session;

FIG. 10 depicts an exemplary embodiment of a disconnect sequence of a communication session;

FIG. 11 shows a flowchart that illustrates the disconnect sequence between any of a receiving party, a calling party, and a third party, occurring during a communication session;

FIG. 12 shows a flowchart that illustrates the disconnect sequence between any of a receiving party, a calling party, and a third party, occurring during a communication session;

FIG. 13 depicts an exemplary embodiment of a transfer when a calling party of an external messaging network interacts with a receiving party, a natural language application, following which, the natural language application initiates a transfer to a third party client on that external network;

FIG. 14 depicts an exemplary embodiment of a transfer when a calling party of an external messaging network interacts with a natural language application, with the natural language application initiating a transfer to a third party client on an internal messaging network; and

FIG. 15 depicts an exemplary embodiment of a transfer when a calling party is interacting with receiving party on a messaging network and the receiving party initiates a context sensitive transfer to third party where the clients are any mix of people and applications.

FIG. 16 depicts an exemplary embodiment of a communication session with active listening;

FIG. 17 depicts an exemplary embodiment of a communication system with the implementation of the active listening FX Options Trading application that monitors communication sessions between a trader and a client, extracts transaction information from the session, and executes the transaction at the trader's request;

FIG. 18 is a flowchart that illustrates a communication session with an implemented active listening application;

FIG. 19 depicts an exemplary embodiment of a communication session with the implementation of active alert; and

FIG. 20 is a flowchart that illustrates the active alert sequence in which an event generator can notify many callers of an event.

### DETAILED DESCRIPTION OF THE PREFERRED EMBODIMENTS

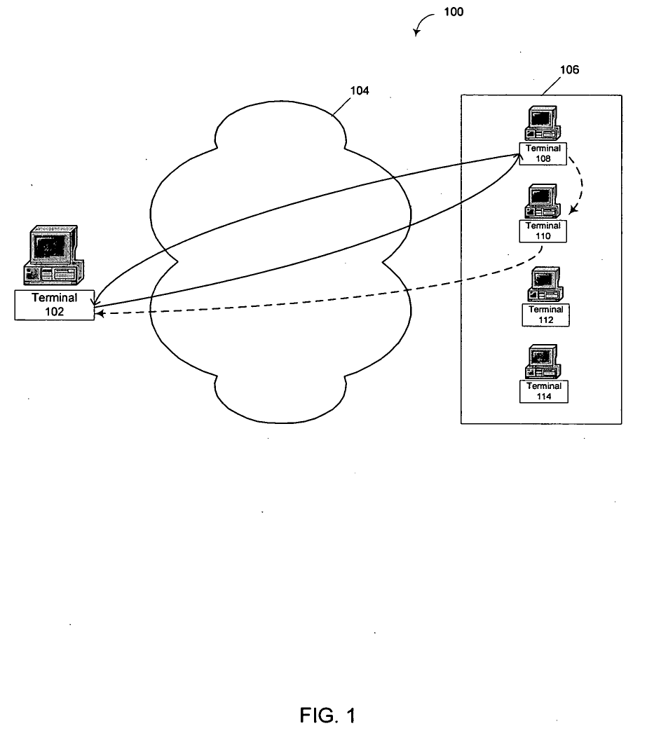

In the descriptions of example embodiments that follow, implementation differences, or unique concerns, relating to different types of systems will be pointed out to the extent possible. But it should be understood that the systems and methods described herein are applicable to any type of network system. The term “terminal” used to identify a calling party terminal, a receiving party terminal, or a third party terminal, is intended to indicate that the various terminals communicate with each other through the computing systems, hardware and software, associated therewith. Thus, depending on the embodiment, the term terminal may refer to one or more terminals, live person interfaces, automated software and/or hardware routines and systems, servers, such as Internet or web servers, file servers, and/or database servers, computing devices, including but not limited to, workstations, computers and wireless devices, networking components, including but not limited to, routers and databases and software applications, including but not limited to, one or more software applications, one or more Application Program Interfaces (APIs), or some combination thereof. An exemplary embodiment of a communication system comprising one or more terminals is described in more detail with respect to FIG. 1.

FIG. 1 depicts a diagram illustrating an example of a communication system 100 configured to incorporate a protocol management system between one or more calling party terminals, receiving party terminals, or third party terminals in a client server network model in accordance with the systems and methods described herein. The network model a calling party can provide a basic overview of the systems used to implement a distribution platform that can allow to be redirected or transferred efficiently from a receiving party to a third party as described below. Specifically, FIG. 1 depicts at least a calling party terminal 102, a receiving party terminal 108, a third party terminal 110, all connected for communication purposes via a communication network 104, such as the Internet.

As described herein, a calling party can use any terminal that can be configured to connected to another terminal. The calling party can constitute one or more automated systems, live persons, servers, such as Internet or web servers, file servers, and/or database servers, computing devices, including but not limited to, workstations, computers and wireless devices, networking components, including but not limited to, routers and databases and software applications, including but not limited to, one or more software applications, one or more Application Program Interfaces (APIs), or some combination thereof.

As described herein, a communication session can refer to any conversation or conversations between terminals in its entirety. The communication session can remain open throughout the entire period the terminals are logged into network 104 and until one or more terminals explicitly terminates the connection. A communication session can constitute any form of communication including, but not limited to, instant messaging.

As described herein, a transfer context can refer to the communication and display of information about the communication session and its participants to a third party upon a transfer of the communication session from a calling party or receiving party to the third party.

As described herein, an application space, or shared memory, can be the location where processes communicate and coordinate their activities by exchanging objects. The application space can be, but is not limited to, a Java Space or an IBM T Space. In one embodiment, the application space can provide the ability to dynamically add a server such as a VoiceXML Browser (VB) or gateway adapter (GA). In another embodiment, the application space can provide a mechanism for callers to write messages as well as read messages. As such, the application space can provide a disconnected storage mechanism such that parties or their terminals need not know where the message is either coming from or going to, thus providing greater flexibility of how the messages can be processed. Messages can be processed based on factors not known by the party or terminal that sent the message. The advantages to the application space described herein include, but are not limited to, providing load balancing, providing flexibility of system design, and requiring no code changes to a message to support new features of system 1000.

In one embodiment, a gateway adapter (GA) can connect a messaging network, or proxy server, to the application space described above.

In another embodiment, a VoiceXML Browser (VB) can interpret natural language applications as written in VoiceXML. In still another embodiment, a VB can be referred to as a Natural Language Server. In other embodiments, Perl interpreters, C++, or Java programs can also act as application engines to interpret natural language applications.

Further, depending on the embodiment, a voice browser adapter (VBA) can connect a VoiceXML Browser to the application space.

As described herein, a client server network model, can make use of one or more internal networks such as a LAN (local area network), WAN (wide area network), locally switched network, or public switched network, some other communication technique, or some combination thereof, by which terminals can communicate with each other. Although one or more embodiments are described herein in which the client server network model can use a LAN, there is no particular requirement that the client server network model include a LAN, or that any particular network configuration be employed. The client server network model, can then use the Internet; however, in other embodiments the client server network model can use, for example, an intranet, extranet, virtual private network (VPN), LAN, WAN, locally switched network or public switched network, some other communication technique, or some combination thereof. Similarly, although an embodiment is described herein where the client server network model including the Internet, there is no particular requirement that the client server network model use the Internet or any other specific type of network.

As described herein, a protocol can support communication among processes which make up a communication session. Thus, protocol can support the establishment of connections, transmission of text messages, and control functions. The protocol can, for example, be operated over a reliable transport such as TCP. A protocol management system, configured in accordance with the systems and methods described herein, can efficiently control the communication between the terminals by defining the types of messages used to communicate. In one embodiment, the protocol management system can define a connect message, a connect accept message, a connect reject message, a message message, a transfer message, a transfer accept message, a transfer busy message, a transfer no answer message, a disconnect message, a disconnect acknowledge message, and a status message.

A message processor can comprise part of a protocol management system configured in accordance with the systems and methods described herein. Such a message processor can take a data message sent to the message processor and place it in a structured format after which the data message can be further manipulated to accomplish a task. Thus, depending on the embodiment, the data message may be further processed to access or query information or data that may reside in memory with the same process as the message processor or in some other data storage device; to access an application that my be contained in the same process or in a separate process; or to authorize participants within a dialog, or communication session, to allow monitoring of applications to limit the resources, data, and services they have access to, or to allow monitoring application to decide how to respond to the other participants. Following processing, the message processor can format an appropriate response and send it to the respondent participant. The message processor can further transfer the communication session as discussed in more detail below.

In one embodiment, a connect message can refer to any message or messages sent from one terminal to another to initiate a communication session. Similarly, depending on the embodiment, of a connect accept message can refer to a reply to a connect message indicating that the connection has been established; a message message can refer to any message sent from one terminal to another comprising the text, or body, that can constitute a message, instruction, or inquiry or any other query or statement; and a disconnect message can refer to any message sent from one terminal to another to tear down a connection.

The disconnect message can comprise status Properties or statistics which the VB has collected. The disconnect message can also comprise transfer flag when the disconnect is sent as party of a transfer sequence. The presence of the transfer flag will prevent the disconnect message from being forwarded beyond the VB, and can cause the voice browser adapter (VBA) to directly acknowledge the disconnect to the VB.

In one embodiment, a disconnect acknowledge message can refer to a reply to the disconnect message. The disconnect acknowledge message can also report statistics regarding status properties when the VB replies to the disconnect message.

In one embodiment, a status message can refer to any message sent by any terminal and particularly can refer to a message sent by the VBA to the logger when the VB sends a disconnect message or a disconnect acknowledge message. A status message can contain information regarding the session length, session completion, session termination, session begin time, session end time, number of messages in the session, session length, and any other relevant data to the communication session.

In one embodiment, a transfer message can refer to any message sent by a receiving party or a calling party to a third party to initiate a transfer of the communication session from the receiving party or calling party to the third party. The transfer message can depending on the embodiment, constitute a connect message. The transfer message can also comprise the identity of the user who initiated the connection, any data or useful information from the initial dialog between the receiving party and the calling party, to alert the third party accepting the transfer and provide continuity. The data or information in the transfer message can be provided by either the calling party or the receiving party in its capacity of gathering information to or about the calling party. The transfer message can also report the transfer destination defining where the transfer is to be made as either a particular terminal or a class. The transfer report can also comprise the session identification so the third party can take over the connection from the receiving party.

In one embodiment, a transfer accept message can refer to a reply to the transfer message indicating the third party can accept the transfer. The transfer accept message indicates that the third party is involved in the connection identified by the session identification and that the connection to the receiving party has been terminated. The calling party becomes aware of the transfer upon receiving a message message from the third party. The session identification used by the receiving party is now used by the third party.

In one embodiment, a transfer busy message can refer to a reply to the transfer message indicating when the third party is already in a connection and cannot accept the transfer. In another embodiment, a transfer no answer message can refer to a reply to the transfer message indicating when the third party does not reply to the transfer message.

By way of introduction, the calling can party place a call or send a message to a call center where a receiving party can answer the call or receives the message and a dialog between the calling party and the receiving party ensues. As will be described below in greater detail, upon receiving an inquiry from the calling party that the receiving party cannot answer, the calling party can transfer the call to a third party, or a third receiving party. The receiving party not only can transfer the call itself to the third party, but also can transfer the communication session including any dialog between the calling party and the receiving party, any information regarding the calling party including, but not limited to, status, location, and identification, and any inquiries the calling party may have that the receiving party could not answer. As such, the third party can continue the call or communication session with the calling party.

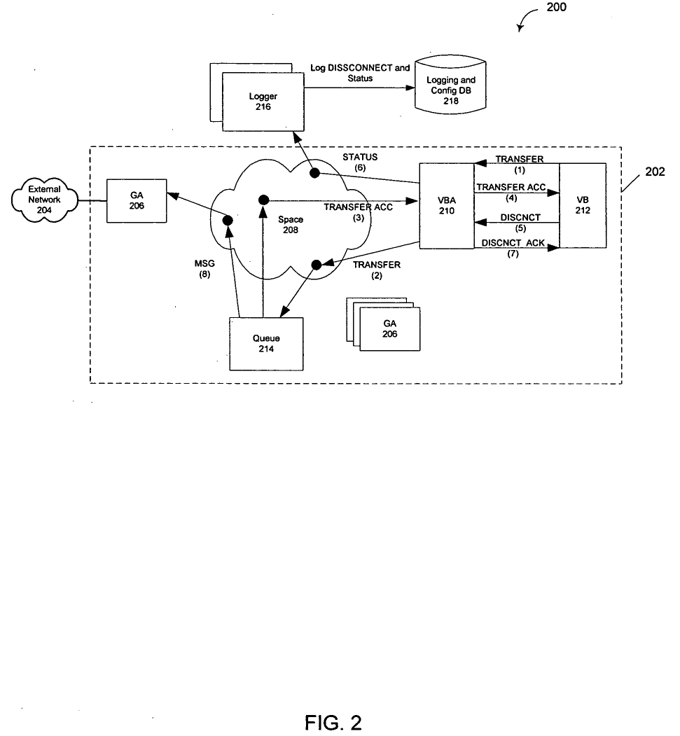

By way of further introduction, FIG. 2 depicts an exemplary embodiment of a transfer sequence of a communication session from a receiving party to a third party in a network 200 configured to interface with a protocol management system 202 in accordance with the systems and methods described herein. In the example of FIG. 2, a VB 212 can send a transfer message to the VBA 210, the VBA 210 can forward the transfer message to application space 208 where it can be picked up by a third party in the queue 214. The third party in the queue 214 then can send the VBA 210 a transfer accept message in reply to the transfer. The VBA 210 then can forward the transfer accept message to the VB 212. The VB 212 then can send a disconnect message to the VBA 210 and can send a disconnect acknowledges message back to the VB 212. The third party in the queue 214 can now connect to the calling party in the external network 204.

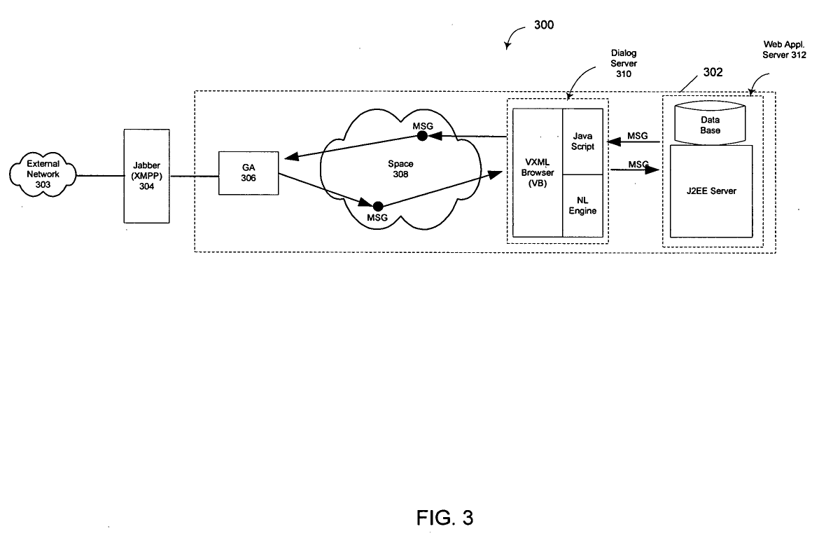

FIG. 3 depicts an exemplary embodiment of an interaction of a calling party to a receiving party in a network 300 configured to interface with a message processor 302 in accordance with the systems and methods described herein. In the example of FIG. 3, through the instant messaging service, Jabber 304, the calling party can send a connect message to the GA 306. The GA 306 can receive the message and forward the message to the application space 308 to the dialog server (DS) 310. DS 310 can then parse the message and determine further action by executing a VoiceXML browser (VB), grammar specifications, and Javascript files to translate between natural language messages and Voice XML directives. The DS 310 can forward the message for the appropriate action in the web application server 312. Web application server 312 can respond with another VoiceXML file with supporting grammar specifications to the DS 310. The DS 310 then can compile the VoiceXML file with supporting grammar into a response and forward the response to the application space 308. The GA 306 then can retrieve the response from the application space 308 and sent it to the calling party.

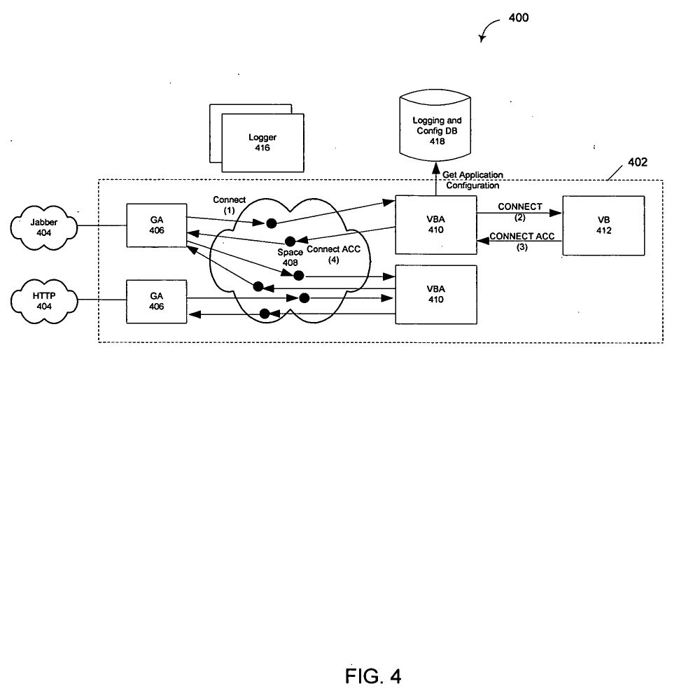

FIG. 4 depicts an exemplary embodiment of a connect sequence of a communication session from a calling party to a receiving party in a network 400 configured to interface with a protocol management system 402 in accordance with the systems and methods described herein. In the example of FIG. 4, through the instant messaging service, Jabber 404, the calling party can send a connect message to the GA 406. The GA 406 can forward the connect message to the application space 408 where an available VBA 410 can receive it. The VBA 410 then can forward the connect message to the VB 412. In reply, the VB 412 can send a connect accept message to the VBA 410. The VBA 410 then can forward the connect accept message to the application space 408 where the GA 406 can retrieve it and sent it to the calling party.

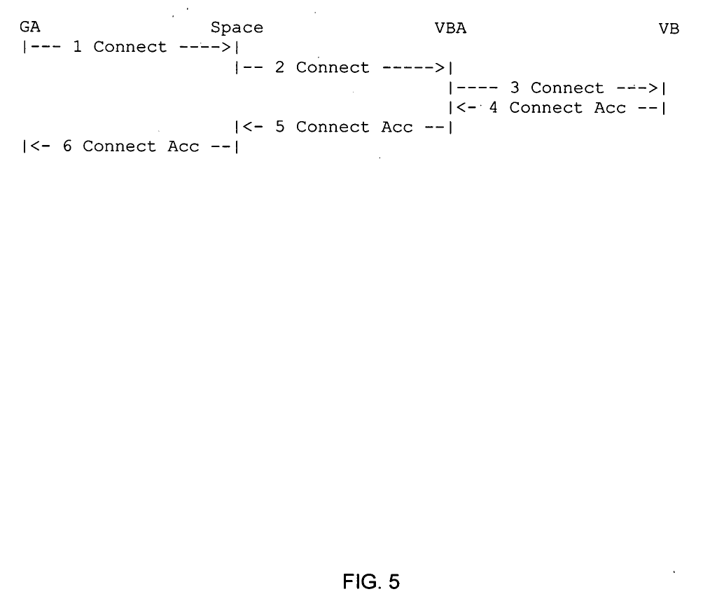

FIG. 5 is a flowchart that illustrates the connect sequence between a calling party and a receiving party. More specifically, FIG. 5 shows the different message types necessary to connect two terminals in a communication session and the intermediary devices that receive and forward the messages.

As shown in FIG. 5, the GA can be contacted by a calling party by sending a message to the GA. The GA can hold the message while it establishes a connection with a VB. The GA can send a connect message addressed to any available VBA to the space. The next available VBA can then retrieve the connect message and can send it to its corresponding VB. The VB can send a connect accept message to the VBA indicating that it is ready for further messages to be sent. The VBA can forward the connect accept message to the application space. The GA can pick up the connect accept message from the space and the connection can be established between the calling party and the receiving party.

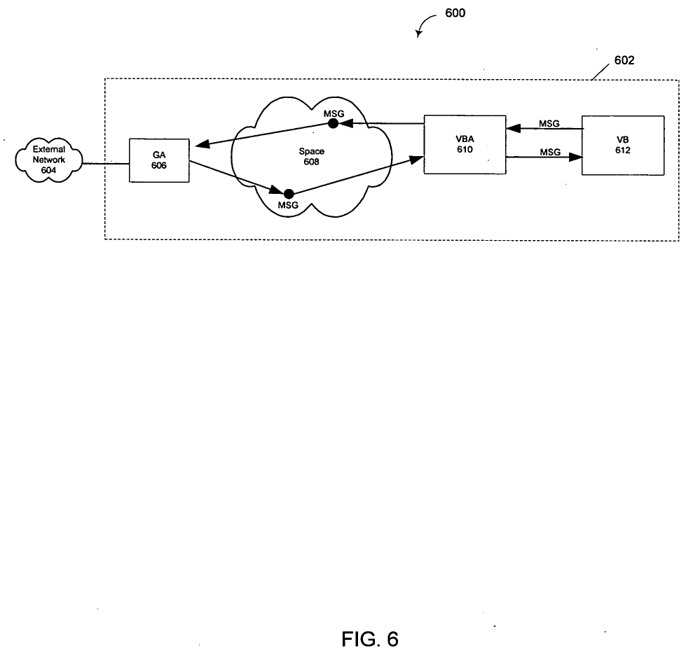

FIG. 6 depicts an exemplary embodiment of a message sequence of a communication session occurring between a calling party to a receiving party in a network 600 configured to interface with a protocol management system 602 in accordance with the systems and methods described herein. In the example of FIG. 6, a calling party in the external network 604 can send a message to the VB 612. The message can enter the protocol management system 602 through the GA 606. The GA 606 can then send the message to the application space 608 where the VBA 610 can retrieve the message and forward the message to the VB 612. The VB 612 can likewise send a message to the calling party in the external network 604 by sending the message to the VBA 610. The VBA 610 then can send the message to the application space 608 where the GA 606 can locate the message and forward it to the calling party in the external network 604.

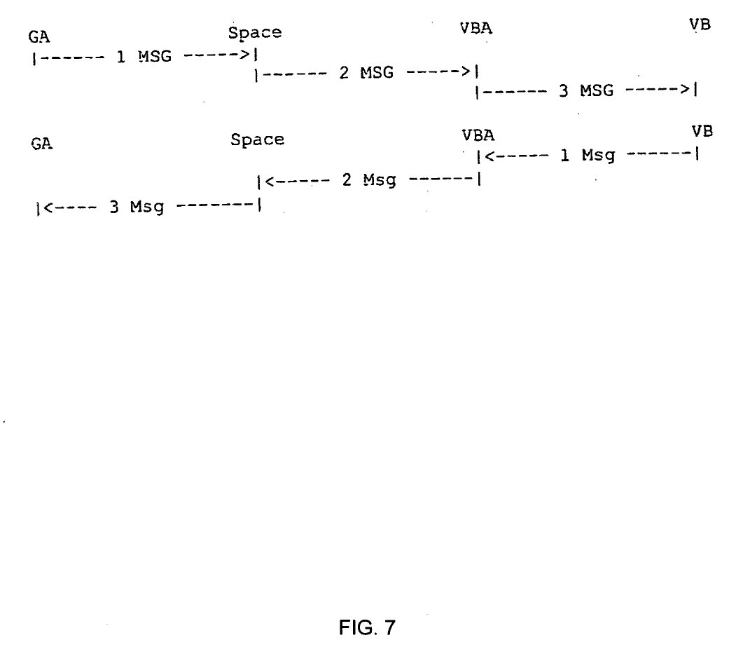

FIG. 7 is a flowchart that illustrates the message sequence between a calling party and a receiving party, or alternatively between a calling party and a third party, or alternatively between a receiving party and a third party, occurring during a communication session and the intermediary devices that receive and forward the messages.

As shown in FIG. 7, the messages can be sent in a straightforward manner without acknowledgement. The messages can be sent from the calling party to pass through the GA, the application space, and VBA the directly to the address of the responding VB. The messages can be sent from the VB to pass through the VBA, the application space and GA directly to the address of the responding terminal.

As described above, FIG. 2 depicts an exemplary embodiment of a transfer sequence of a communication session occurring between a calling party to a receiving party in an network 200 configured to interface with a protocol management system 202 in accordance with the systems and methods described herein.

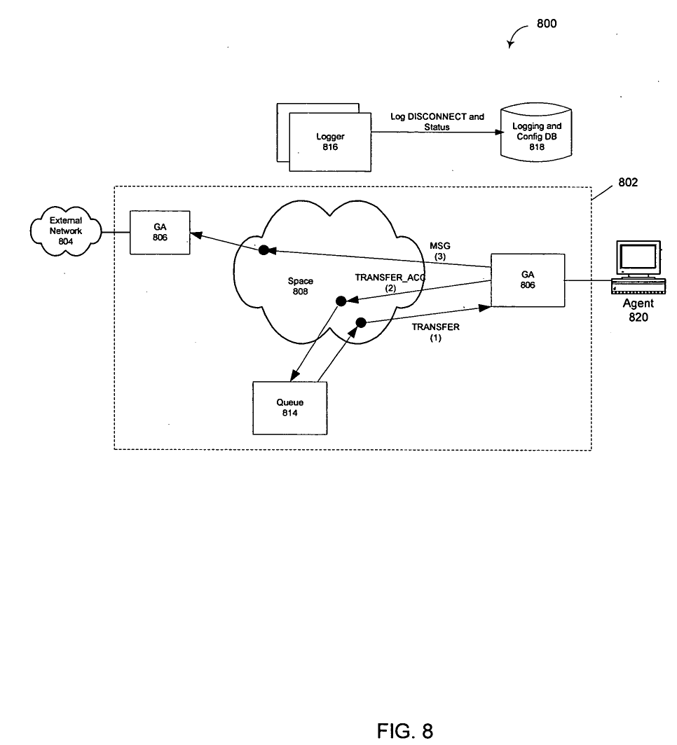

FIG. 8 depicts another exemplary embodiment of a transfer sequence of a communication session occurring between a receiving party to an external third party through a network 800 configured to interface with a protocol management system 802 in accordance with the systems and methods described herein. In the example of FIG. 8, a receiving party in the queue 814 can send a transfer message to a third party agent 820 sitting outside the network 800. The receiving party in the queue 814 can send the transfer message to the application space 808 where the GA 806 can retrieve it. The GA 806 can then forward the transfer message to a third party agent 820. The third party agent 820 can reply by sending a transfer accept message to the GA 806. The GA 806 can then forward the transfer accept message to the application space 808 where it can be retrieved by the receiving party in the queue 814. The third party agent 820 can then proceed to send messages through the GA 806 and, alternatively through the application space 808 and another GA 806, to the calling party in the network 804.

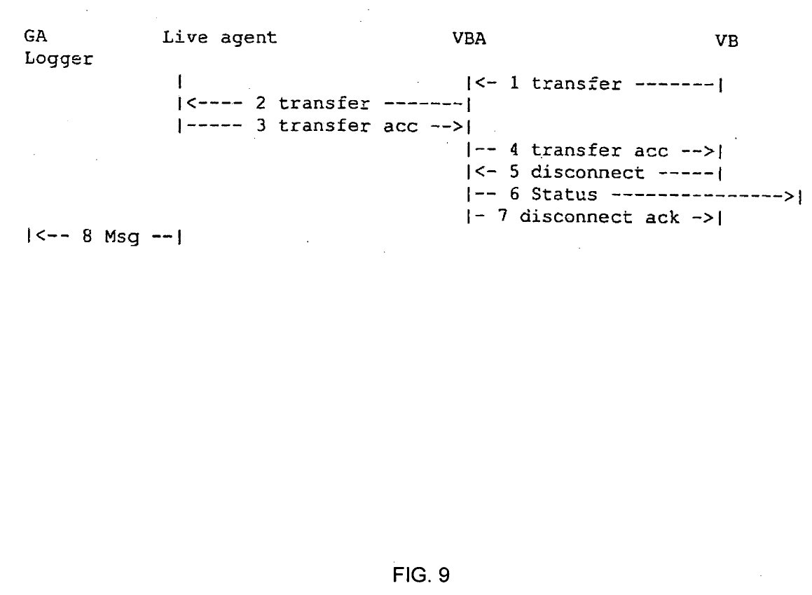

FIG. 9 is a flowchart that illustrates the transfer sequence between a receiving party and a third party, or alternatively between a calling party and a third party, occurring during a communication session and the intermediary devices that receive and forward the messages.

As shown in FIG. 9, the VB can initiate a transfer by sending a transfer message to the VBA. The VBA can forward the message to the application space with either the address of a specific third party terminal or the address of a class of terminals. A third party, a live agent, can pick up the transfer message from the application space. The live agent can accept the transfer and then can send the VBA a transfer accept message in reply to the transfer message. The VBA can forward the transfer accept message to the VB. The VB can then log is statistics by sending a disconnect message to the VBA with the statistics. The disconnect message can contain a transfer flag property to prevent the disconnect message from being forwarded to the GA. The GA can collect the statistics from the disconnect message and can send the status to the logger. The VBA can send the VB a disconnect acknowledge message.

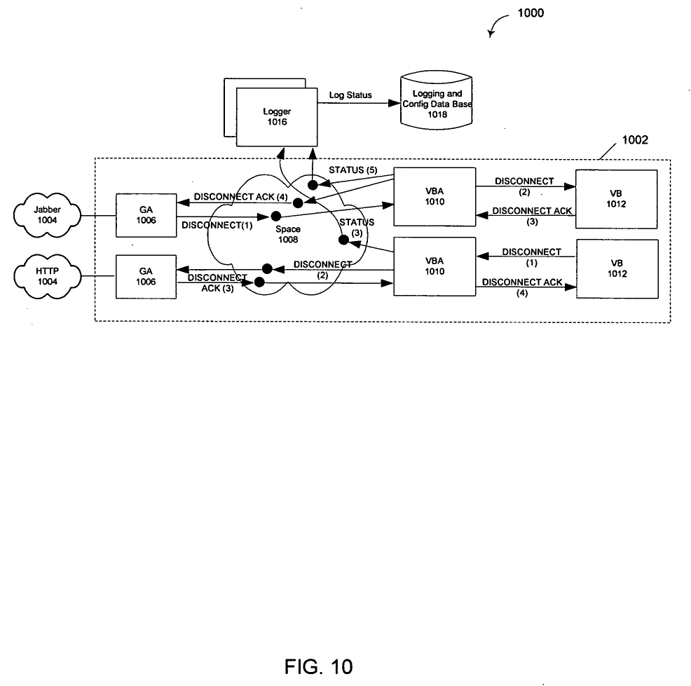

FIG. 10 depicts an exemplary embodiment of a disconnect sequence of a communication session occurring between a calling party to a receiving party and from a receiving party to a calling party in a network 1000 configured to interface with a protocol management system 1002 in accordance with the systems and methods described herein. In the example of FIG. 10, following the disconnect sequence that can be initiated by a calling party, a calling party using the instant messaging service, Jabber 1004, can send a disconnect message to the GA 1006. The GA 1006 can then send the disconnect message to the space 1008 where the VBA 1010 can pick it up. The VBA 1010 can forward the disconnect message to the VB 1012. In reply to the disconnect message, the VB 1012 can send a disconnect acknowledgment message including the session statistics to the VBA 1010. The VBA 1010 can then forward the session statistics to the logger 1016 and can forward the disconnect acknowledgment through the space 1008 to the GA 1006. The GA 1006 can then forward the disconnect acknowledgment message further to the calling party using the instant messaging service, Jabber 1004.

Alternatively, in the example of FIG. 10, the disconnect sequence that can be initiated by a receiving party. The VB 1012 can initiate the disconnection by sending a disconnect message with the session statistics to the VBA 1010. The VBA 1010 then can forward the session statistics to the logger 1016. The VBA 1010 also can send the disconnect message to the application space 1008. The GA 1006 can pick up the disconnect message from the application space 1008 and forward the disconnect message to the calling party using the instant messaging service, HTTP 1004. The calling party using the instant messaging service, HTTP 1004, can then reply be sending a disconnect acknowledgement message through the GA 1006 to the space 1008. The VBA 1010 can then retrieve the disconnect acknowledgment message from the space 1008 and forward it to the VB 1012.

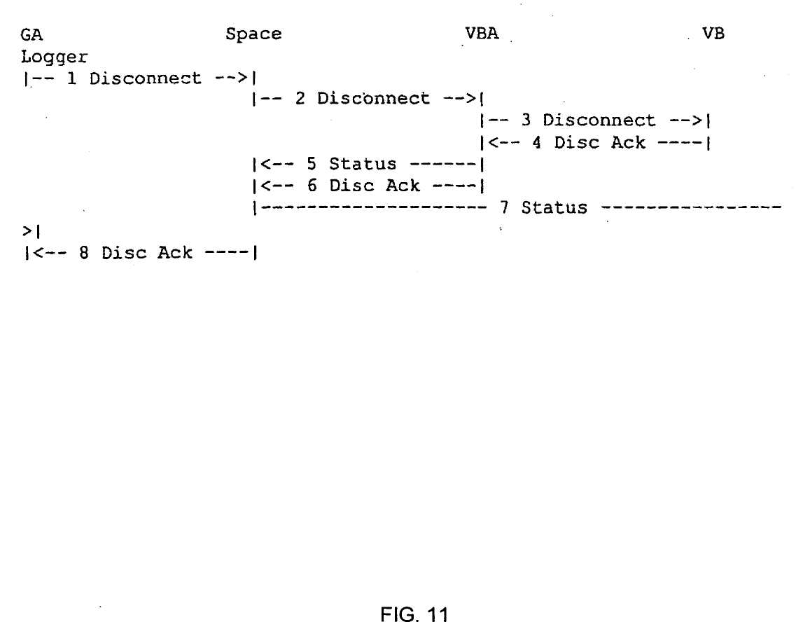

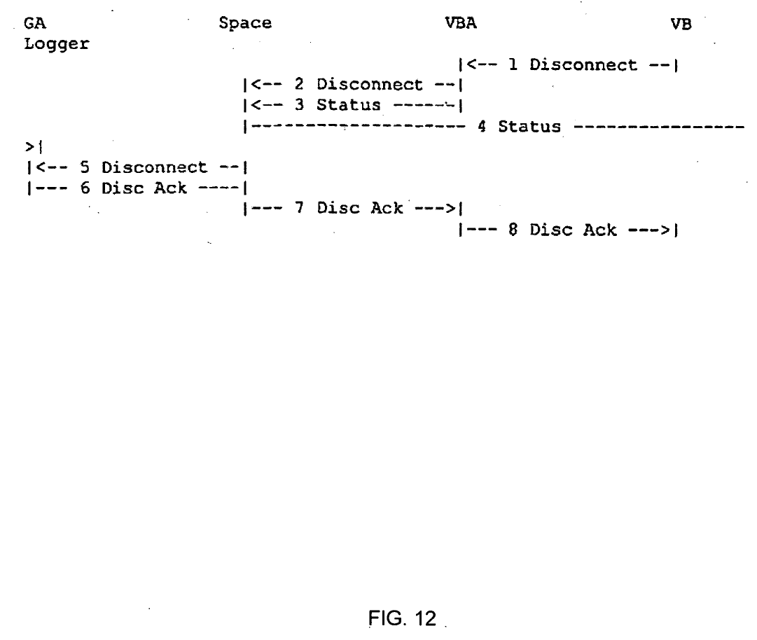

FIGS. 11 and 12 are flowcharts that illustrate the disconnect sequence between any of a receiving party, a calling party, and a third party, occurring during a communication session and the intermediary devices that receive and forward the messages. The disconnect message terminates the connection. Either party may initiate the disconnect.

As shown in FIG. 11, either the GA or the calling party can initiate the disconnect by sending a disconnect message. The GA can forward the disconnect message to the application space. The VBA can pick up the disconnect message from the space and forwards it to its VB. The VB can then send a disconnect acknowledgment message that can contain the session statistics to the VBA that then can forward the disconnect acknowledgment message to the application space. The session statistics can be picked up by the logger. The GA can pick the disconnect acknowledgment message from the application space.

As shown in FIG. 12, the VB can initiate the disconnect by sending a disconnect message to the VBA. The disconnect message sent by the VB can contain session statistics. The VBA then can forward the disconnect message to the application space and can send the statistics to the logger. The GA can then send a disconnect acknowledge message to the space, where it can be picked up by the VBA and forwarded to the VB.

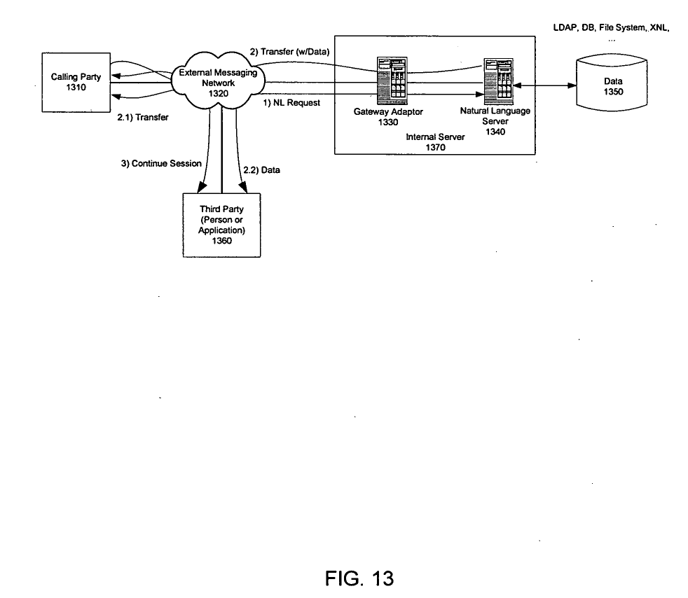

As shown in FIG. 13, a further embodiment of the invention can be a transfer when a calling party of an external messaging network can interact with a natural language application, following which the natural language application can initiate a transfer to a third party client on the same or a different external network. In the example of FIG. 13, a calling party 1310 can send a natural language request to a external messaging network 1320. The external messaging network 1320 can send the natural language request to the internal server 1370 through the gateway adapter 1330 to the natural language server 1340. The natural language server 1340 can retrieve data 1350 and send a transfer message through the gateway adapter 1330 to the external messaging network 1320. The external messaging network 1320 can forward the transfer message with the data, including but not limited to session statistics and the dialog from the communication session, to the third party 1360. The calling party 1310 can be notified of the transfer and can continue the session with the third party 1360 through the external messaging network 1320.

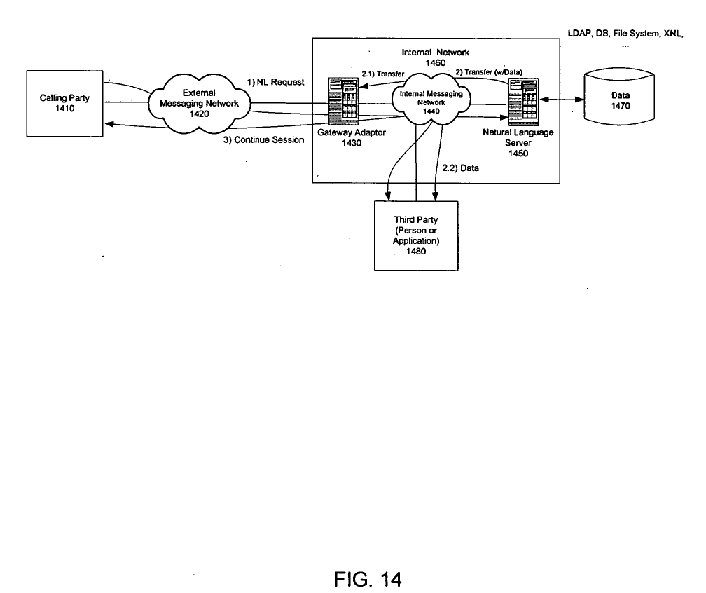

As shown in FIG. 14, a further embodiment of the invention can be a transfer when a calling party of an external messaging network interacts with a natural language application, with the natural language application initiating a transfer to a third party client on an internal messaging network. In the example of FIG. 14, a calling party 1410 can send a natural language request through an external messaging network 1420 to a receiving natural language server 1450. The external messaging network 1420 can forward the natural language request to the internal network 1460 through the gateway adapter 1430. The gateway adapter 1430-can send the natural language request to the internal messaging network 1440. The natural language server 1450 then can retrieve the natural language request and obtain the data 1470 to answer the request. The natural language server 1450 can then transfer the data 1470 and communication session to a third party 1480 coupled to the internal messaging network 1440 by sending a transfer message to the internal messaging network 1440. The third party 1480 then can retrieve the transfer message with data, including but not limited to session statistics and the dialog from the communication session, from the internal messaging network 1440. The gateway adapter 1430 also can retrieve the transfer message without the data and can forward the transfer message to the external messaging network 1420 where the calling party 1410 can pick it up. The calling party 1410 can now continue the session through exchanging messages with the third party 1480.

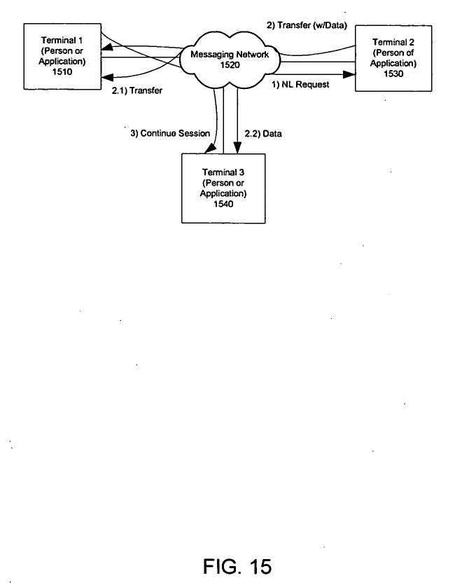

As shown in FIG. 15, a further embodiment of the invention can be a transfer when a first terminal is interacting with second terminal on a messaging network and the second terminal initiates a context sensitive transfer to third terminal where the clients are any mix of people and applications. In the example of FIG. 15, a first terminal 1510 can send a natural language request to a second terminal 1530 through a messaging network 1520. The second terminal 1530 can retrieve the natural language request from the messaging network 1520. The second terminal can send a transfer request with data to a third terminal 1540 by sending the transfer request to the messaging network 1520. The third terminal 1540 can retrieve the transfer with data, including but not limited to session statistics and the dialog from the communication session, from the messaging network and the first terminal 1510 can retrieve the transfer message without data to notify the first terminal 1510 of the transfer. The first terminal 1510 can then engage in a continuation of the communication session with the third terminal 1540 through the messaging network 1520. The second terminal 1530 can be disconnected from the continuing communication session.

In another embodiment, where the application is written in the VoiceXML scripting language, a transfer can be completed using the VoiceXML transfer tag in an IM network. The transfer tag can communicate the name of a transfer variable including “busy”, “noanswer”, “dest”, “connecttimeout”, and “data”. The “busy” variable can indicate the destination resource is busy and cannot accept the transfer request. The “noanswer” variable can indicate that no transfer response was received within the time specified by “connecttime”. The “dest” variable can indicate the destination of the transfer. The “connecttimeout” variable can indicate the time the platform waits when attempting a connection before aborting the transfer attempt and assigning the transfer variable the value “noanswer”. The “data” variable can indicate a block of data to be passed on with the transfer request.

By way of introduction, the messages of a communication session between a calling party and a receiving party can be intercepted, processed, and responded to in an automated process in real-time. In one embodiment, this interception process, known as “active listening,” can optimize workflows by automatically extracting information from a conversation on a network to conduct a transaction, for example trading stock. In another embodiment, active listening can be implemented to enforce regulations and policies of the network, control rules of engagement, and make conversations more secure. In a further embodiment, active listening can provide “in-band” directory assistance and conference control. In yet another embodiment, active listening can ensure high quality of customer service.

As described herein, monitoring communication sessions can refer to the notion of a third party or application reviewing the messages sent between to or more callers in a network. Also described herein, intercepting communication session messages can refer to taking a message sent by one calling party to one or more other calling parties before it reaches the intended recipient calling parties. The monitoring and intercepting of communication sessions can be conducted by the same entity or application. In one embodiment, the entity or application can be an automated application.

Messages of a communication session can be intercepted at several locations. For example, in one embodiment, messages can be intercepted through a proxy. In another embodiment, messages can be intercepted through a “buddy”, or third party, that sits in a conference on a communication session between a calling party and a receiving party. In yet another embodiment, messages can be intercepted on a client. In another embodiment, messages can be intercepted on the server, or through any process that has direct communication with a server, but not as a client.

Messages of a communication session that are intercepted can be further processed. After processing the intercepted message and it is determined that a response is required, the active listening application can determine whether a response will be sent to any or all of the calling parties and receiving parties in the communication session. After the active listening application determines who the response will be sent to, the application can format the responses and forward them to the appropriate calling parties.

The functions of the active listening application can include intercepting the message, processing the message, and responding to the message. These functions can be accomplished by the same application, separate applications, or any combination of the three. In one embodiment, functionality of each individual function can be contained in the same application. In another embodiment, functionality of the individual functions could be assigned to multiple applications in any combination. Thus, the functions of the applications are not restricted to residing on any one application.

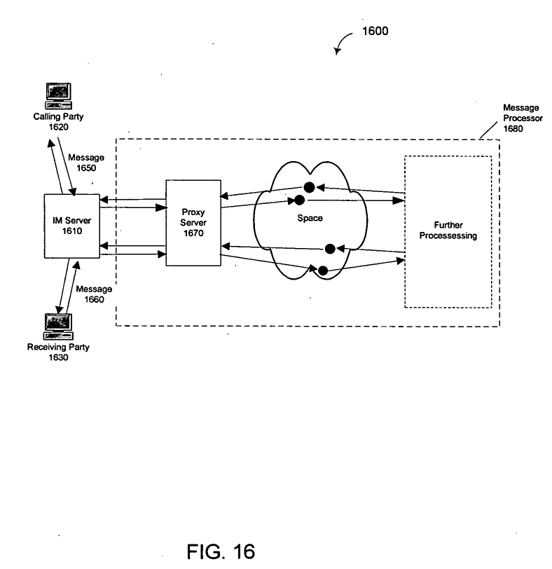

As discussed above, one aspect of a communication system to accomplish active listening of a communication session can be a message processor. In one embodiment, a message processor can sit between calling and receiving parties engaged in a communication session. The message processor can intercept a message, process the message, and respond to the message as described above and depicted in FIG. 3 and below in FIG. 16.

FIG. 16 depicts an exemplary embodiment of a communication session with active listening. Communication system 1600 comprises IM server 1610, calling party 1620, receiving party 1630, and message processor 1680. Message processor 1680 further comprises an automatic application 1670. In one embodiment, automated application 1670 can be a proxy server that, along with IM server 1610, facilitates the communication between calling party 1620 and receiving party 1630. Calling party 1620 can communicate with receiving party 1620 in a real-time IM conversation, where calling party 1620 and receiving party 1630 can each represent a person or an automated agent. The communication between calling party 1620 and receiving party 1630 can be peer-to-peer or can traverse one or more servers. Message processor 1680 can sit between calling party 1620 and receiving party 1630 within a conversation, for example messages 1650 and 1660 can comprise a conversation. The functions of message processor 1670 can include intercepting, processing, and responding to messages. Automated application 1670 can monitor messages being sent between calling party 1620 and receiving party 1630, and can intercept the messages before they reach their intended recipient. For example, when calling party 1620 sends a message 1650 to receiving party 1630, the message 1650 can be first intercepted by automated application 1670 before reaching receiving party 1630. Thus, automated application 1670 of message processor 1680 can both monitor and intercept messages within a communication session.

Once message 1650 is intercepted by automated application 1670, it can be sent to message processor 1680, where it can be placed in a structured format that can undergo processing. Message processor 1670 can process message 1650 in a variety of ways, including, for example, to access or query information that may reside in memory with same process as the message processor or in some other data store, or to access an application that may be contained in the same process or in a separate process. Message processor 1680 can also use message 1650 to authorize and assign roles to participants within a communication session. This allows for the monitoring application (for example, automated application 1670) to limit the accessible resources, data, and services, and also allows the monitoring application (for example, automated application 1670) to decide how to “respond” to participants (for example, terminals 1620 and 1630). Messages, messages 1650 and 1660, can be processed by the same application from which they where intercepted, in a separate application, or both.

Once message 1650 is processed by message processor 1680, a response may or may not be sent to any or all participants in the conversation, for example, terminals 1620 and 1630. If after message 1650 is processed it is determined that a response is required, message processor 1680 can determine to whom the response should be sent, how the response should be to be formatted, after which it can send the message. These functions can all be contained within the same application, separate applications, or any combination thereof. Moreover, the functionality of each individual function can be contained in the same application, or can be “split” among multiple processes. These “splits” can also be combined in any way with “splits” from other functions,, because there are no restrictions as to what applications any of the functions in message processor 1680 reside on.

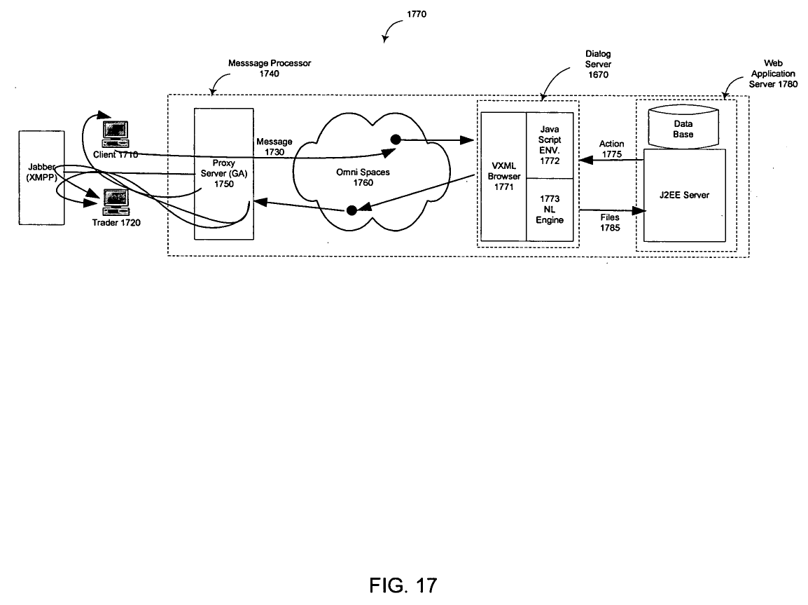

FIG. 17 illustrates an exemplary embodiment of an active listening application, for example, active listening application 1700, that implements the active listening process of FIG. 16. In one embodiment, active listening application 1700 can be an FX Options Trading Application that monitors communication sessions between a trader(s) and client(s), extracts transaction information from the session, and then executes the transaction at the trader's request. Active listening application 1700 can comprise two callers, for example client.1710 and trader 1720 respectively, IM server 1730, and message processor 1740. Message processor 1740 further comprises proxy server 1750, OmniiSpaces 1760, dialog server 1770, and web application server 1780. Dialog server 1770 can further comprise VoiceXML browser 1771, Java script environment 1772, and Natural Language (NL) engine 1773. NL engine 1773 can include an extended CFG parser, finite state parser, and message normalization. In general, client 1710 can communication with trader 1720 via IM server 1730 and proxy server 1750 of message processor 1740. In one embodiment, the implementation of active listening application 1700 can be in text mode and IM server 1730 can be in Jabber (XMPP). Proxy server 1750 is an automated application (for example a gateway adapter) that can intercept communication session message 1715, authorize callers, and assign roles to them. With the exception of authorization, message processing is separate from message interception. A more detailed description of active listening application 1700 follows.

The active listening session can begin when client 1710 sends a message 1715 to proxy server 1750. Proxy server 1750 can then forward message 1715 to trader 1720 via IM server 1730 and dialog server 1770. Since message 1715 could be a message from the chat room itself, or alternatively, a message from one caller to another, this distinction can made known to the NL engine 1773 of dialog server 1770 by the inclusion of a field designating the message as “FROM” or “TO” to the Natural Messaging Protocol (NMP), respectively. As shown in FIG. 17, message 1715 passes through OmniSpaces 1760, which allows client 1710 and trader 1720 to talk with one another asynchronously. OmniSpaces 1760 can be a platform that is strongly based on the computing paradigm “tuple spaces.” Dialogue server 1770 parses message 1715 and determines the action 1775 to take, for example “HTTP GET,” and forwards this action to web application server 1780. Web application server 1780 processes action 1775 and responds by executing VoiceXML, Javascript, and grammar files 1785 in order to translate between free-flow natural language messages and VoiceXML directives.

The dialog server 1770 then can compile the VoiceXML, Javascript and grammar files 1785, send a response to client 1710 and trader 1720, and await the next action. In order to assist the callers, for example client 1710 and trader 1720, NL engine 1773 can be aware of the roles of each calling party. For example, client 1710 can be designated the role of “customer,” a non-privileged user in the session, while trader 1720 can be designated the role of “trader,” a privileged user in the session. These role names are only given by way of example and the actual role names are configurable in the chat proxy database in proxy server 1750. Finally, proxy server 1750 can forward a message 1790 to any or all callers including, for example, trader 1720.

In accordance with the above description of application 1700, proxy server 1750 can be a transparent chat proxy between a client 1710 and the IM server 1730. The proxy server 1750 allows the NL engine running in the dialog server to participate in the communication session between two callers. However, messages between callers are mediated by the IM server 1730. A message from one caller to another is not typically handled by the proxy server 1750 alone. For example, the trader can connect to the IM server via the proxy server 1750. The client can connect to either the proxy server 1750 or directly to the IM server 1730. The proxy server 1750 can provide functions to support the NL engine 1771 without functions to authenticate callers or manage buddy lists. The proxy server 1750 can be programmed to accept any IM protocol to allow simple plug and play operation.

Further, the transparent proxy server 1750 will not interfere with normal communication session operations, and a client 1710 can contact a trader 1720 directly using the trader's IM address and vice versa. As a result, proxy server 1750 can provide various advantages over conventional communication session chat rooms. These advantages include the ability to send messages to only one caller, the ability to prevent a caller from viewing or hearing other callers' traffic, and the ability to delay creation of the NL session and send a history log. Furthermore, the communication session can remain in the initial chat window, the dialog server can see and identify trader and client messages, and the dialog server is able to communicate privately with the trader. Another advantage of the transparent chat proxy of active listening application 1700 is that proxy server 1750 does not interfere with the caller's communication session. For example, when a conventional chat room is used to establish a three-way conversation, the chat room must be created and the third user must be invited to join in, such that the chat interferes with the ability of the trader or client to contact each other directly. Moreover, the transparent chat proxy of active listening application 1700 does not interfere with existing mechanisms of IM servers that log the dialog between the trader and the client. Further advantages include that the messages sent to a caller from the dialog server can be logged by the IM server, but private messages sent between the trader and the dialog server are not required to be logged. In one embodiment, the client is not required to log the messages of the communication session.

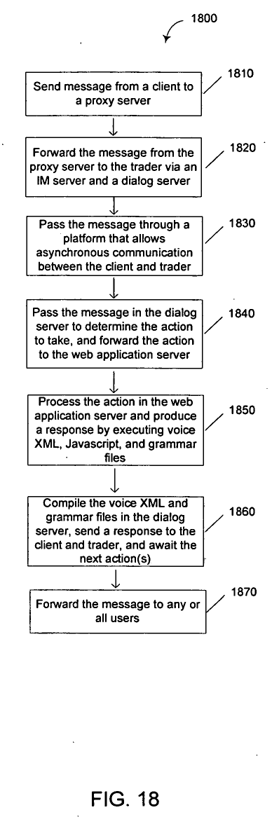

FIG. 18 is a flowchart that illustrates a communication session with an implemented active listening application and, specifically illustrates an active listening session 1800 as implemented by active listening application 1700 of FIG. 17. At step 1810, a client can send a message to a proxy server. Next, at step 1820, the proxy server can forward the message to the trader via an IM server and a dialog server. At step 1830, the message can be passed through a platform that allows the client and the trader to talk with one another asynchronously. In step 1840, the dialogue server can parse the message and determine the action to take, for example “HTTP GET,” and forward this action to a web application server. Next, in step 1850, the web application server can process the action and respond by executing VoiceXML, Javascrpt, and grammar files in order to translate between free-flow natural language messages and VoiceXML directives. Then, in step 1860, the dialog server can compile the VoiceXML and grammar files, send a response to the users, and await the next action(s). Finally, in step 1870, the proxy server can forward a message to any or all users.

A communication system with active listening can follow the same sequences as discussed in FIGS. 5 through 12 above, including the connect sequence, the message sequence, the transfer sequence; and the disconnect sequence.

As mentioned previously, callers to a communication session network are often interested in being alerted when certain events occur. Thus, it would be desirable to have a system that is capable of sending outgoing event notifications, for example, “active alerts”, to interested callers that can initiate a communication session directly from the alert. In some instances, an event may require alerting only one caller. In other instances, an event may require alerting many callers. In one embodiment, events can be initiated outside the communication session network. The event can be triggered by an number of reasons, including, for example, when a stock reaches a certain level, when a news story erupts, or when a callers auction item has been sold. In one embodiment, the notifications, or active alerts, can be sent to all registered callers, even if there are a thousand registered callers. If a caller is not registered, the caller can be added.

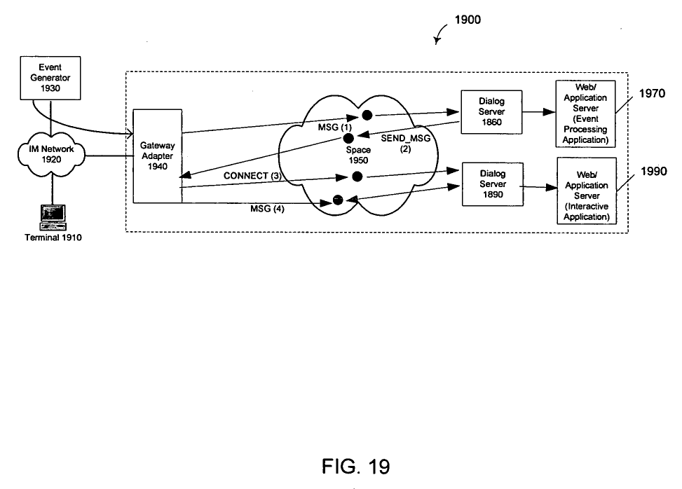

FIG. 19 depicts an embodiment of a communication session with the implementation of active alert. Active alert session 1900 comprises a user 1910, IM network 1920, event generator 1930, gateway adapter (GA) 1940, space 1950, dialog servers 1960 and 1990, and web application servers 1970 and 1980. An event can be generated in event generator 1930 and sent through IM network 1920 to GA 1940. The GA 1940 can then send a message through the space 1950 to the dialog server 1960. The dialog server 1960 further can forward the message to web application server 1970 for further event processing. The message can then be forwarded to the caller 1910 through the dialog server 1960, the space 1950, the GA 1940 and the IM network 1920. If the caller decides to respond, the caller can send a response message and initiate a communication session through the IM network 1920, GA 1940, space 1950, dialog servers 1990, and web application servers 1980.

When the GA 1940 sends the message, this does not create a communication session between the GA 1940 and dialog server 1960. The message is simply sent to the registered caller. When the registered caller replies, the sequences defined above create a communication session. Thus, in one embodiment, communication sessions are not created when an even notification message is sent, but when the registered caller replies. This is possible because GA 1940 knows the IM address of the event generator 1930. When a message is received from an event generator 1930, the GA 1940 can create a communication session with a VoiceXML application that is specially written to handle event notifications, for example, a communication channel is created with the GA itself. In other words, receiving the event notification message will create an app-to-app communication session. The message received from the event generator 1930 can be used as the first message in this app-to-app communication session. This VoiceXML app uses the communication session with the GA 1940 to send the GA commands. For example, the GA 1940 can be commanded to send messages to users, and can reply with the status of the command completion.

The GA 1930 can be associated not only with a single VoiceXML application, but rather, active alert session 1900 allows each GA to be associated with one VoiceXML application for callers, and another application for event generators. For instance, a particular GA in active alert session 1900 can know about more than one event generator and associate a VoiceXML application with each of them. By having the GA create a new session to connect a user and a specified VoiceXML application, existing mechanisms can be used to allocate a VoiceXML browser, such that scaling is achieved by spreading the new connections across the available VoiceXML browsers. The GA to VoiceXML application can send messages where the text of the message is in a structured format suitable for app-to-app communication. This communication is structured using similar sequences to those described above in FIGS. 5 through 12.

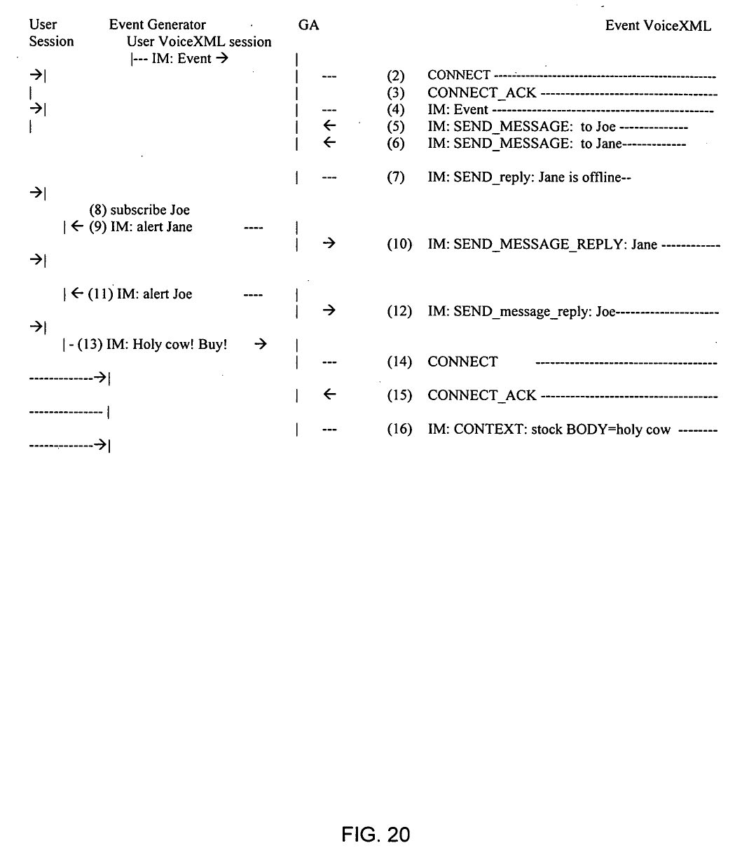

FIG. 20 is a flowchart that illustrates the active alert sequence in which an event generator can notify many callers of an event. More specifically, FIG. 20 shows the different message types necessary to notify those registered callers of an event and further initiate a communication session between callers and the intermediary devices that receive and forward the messages.

As shown in FIG. 20, the GA can be contacted by an event generator by sending a message containing an event, the “event message”, and written to the GA as an application written to handle the event. The GA can hold the event message while it creates a session. The GA can send a connect message addressed to a VoiceXML browser in search of a VoiceXML application that can handle the event. After a VoiceXML application is located, the VoiceXML browser can accept the connection and send back a connect acknowledgement message. The GA then can send the event message being held to the VoiceXML application. The VoiceXML application located can determine the callers to be notified by referencing the GA's. “buddy list.” For each user, the VoiceXML application can create a message to alert the caller and can send the message to the GA using a send message message. The send message message can include the IM address of the caller and a text message to send to the caller. The GA can receive the send message message. In one embodiment, the VoiceXML application also notifies a caller, “Jane.” If the message cannot be sent to Jane, for example, Jane is offline, a send message reply can be sent indicating the reason the communication session could not be created. In another embodiment, “Joe” is not on the GA's “buddy list.” The GA can communicate with the IM network to subscribe Joe. The GA can send a message to Jane. The GA further can send a reply message to the VoiceXML application indicating the message was sent to Jane. The GA can sent a message to Joe, now subscribed to the GA's buddy list. The GA further can send a reply message to the VoiceXML application indicating the message was sent to Joe. Joe can reply immediately to the message. The GA then can establish a communication session between the VoiceXML application and Joe. The VoiceXML browser can accept the connection with Joe. As Jane never replied to the message sent from the GA, the message can expire, thus conserving network-resources.

While certain embodiments of the inventions have been described above, it will be understood that the embodiments described are by way of example only. Accordingly, the inventions should not be limited based on the described embodiments. Rather, the scope of the inventions described herein should only be limited in light of the claims that follow when taken in conjunction with the above description and accompanying drawings.

1. A system configured to perform active listening on a communication session comprising:
a first terminal;
a second terminal configured to engage in a communication session with the first terminal; and
an application configured to:
intercept a message of the communication session between the first terminal and the second terminal before the message reaches its intended recipient;
process the intercepted message; and
send a response message to either of the first terminal or the second terminal, or any third terminal in response to the processed message.

2. The system of claim 1, wherein the communication session is an instant message session.

3. The system of claim 1, wherein the communication session is a SMS session.

4. The system of claim 1, wherein the communication session is an html session.

5. The system of claim 1, wherein the communication session in which the first terminal and the second terminal are engaged in further includes a dialog between the first terminal and the second terminal.

6. The system of claim 1, wherein the response message comprises:
an identity of the first terminal and the second terminal that is used to establish a connection between the first terminal and the second terminal;
information collected about the first terminal and second terminal; and
information related to a particular third terminal, or a class of terminals, associated with the communication session.

7. The system of claim 6, wherein the third terminal information includes information related to a particular third party, a specific live person, a class of terminals, or a group of live agents.

8. The system of claim 1, wherein the application is further automated.

9. The system of claim 1, wherein the application intercepts, processes, and responds in real time.

10. The system of claim 1, wherein the message of the communication session is intercepted through a proxy.

11. The system of claim 1, wherein the message of the communication session is intercepted through a third terminal that is also engaged in the communication session.

12. The system of claim 1, wherein the message of the communication session is intercepted on a client.

13. The system of claim 1, wherein the message of the communication session is intercepted on a server.

14. The system of claim 1, wherein the application processes the message by accessing information that resides in the memory within the same process or a different process.

15. The system of claim 1, wherein the application sends a response message after the application determines the location to send the response message and formats the response message.

16. The system of claim 1, further comprising a plurality of applications, the plurality of applications configured to intercept a message, process the message, and send a response message.

17. A method for performing active listening on a communication session being conducted between a first terminal and a second terminal, the method comprising:
intercepting a message of the communication session between the first terminal and the second terminal before the message reaches its intended recipient;
processing the intercepted message; and
sending a response message to either of the first terminal, the second terminal, or a third terminal in response to the processed message.

18. The method of claim 17, wherein the communication session in which the first terminal and the second terminal are engaged in further includes a dialog between the first terminal and the second terminal.

19. The method of claim 17, wherein the communication session is an instant message session.

20. The method of claim 17, wherein the communication session is a SMS session.

21. The method of claim 17, wherein the communication session is an html session.

22. The method of claim 17, further comprising generating the response message, wherein generating the response message comprises determining an identity of the first terminal and the second terminal that is used to establish a connection between the first terminal and the second terminal and using the identity to generate the response message.

23. The method of claim 17, further comprising generating the response message, wherein generating the response message comprises collecting information about the first terminal and the second terminal and using the collected information to generate the response message.

24. The method of claim 17, further comprising generating the response message, wherein generating the response message comprises collecting information related to a particular third terminal, or a class of terminals, associated with the communication session and using the collected information to generate the response message.

25. The method of claim 24, wherein collecting information related to a third party comprises collecting information related to a particular third party, a specific live person, a class of terminals, or a group of live agents.

26. The method of claim 17, wherein the steps of intercepting, possessing, and responding occur in real time.

27. The method of claim 17, wherein the message of the communication session is intercepted through a proxy.

28. The method of claim 17, wherein the message of the communication session is intercepted through a third terminal that is also engaged in the communication session.

29. The method of claim 17, wherein the message of the communication session is intercepted on a client.

30. The method of claim 17, wherein the message of the communication session is intercepted on a server.

31. The method of claim 17, wherein sending a response message comprises sending a response message after the determining a location to send the response message and formatting the response message.

32. A system configured to distribute outgoing interactive alerts on a communication system comprising:
a terminal configured to receive a message, and to send a response and initiate a communication session in response to the received message;
an event generator configured to send an event message; and
a dialog server configured to receive the event message and to send the message to the terminal in response to the received event message.

33. The system of claim 32, wherein the event generator is located outside the communication system.

34. The system of claim 32, wherein the dialog server is configured to contact a plurality of terminals in response to the received event message.

35. The system of claim 34, wherein at least some of the plurality of terminals are connected to an external network.

36. The system of claim 32, wherein the terminal is connected to an external network.

37. A method for distributing outgoing interactive alerts on a communication system, the method comprising:
receiving an event message from an event generator for distribution to a terminal;
processing the event message to determine intended recipient terminals;
sending the event message to the intended recipient terminals without created a communication session, wherein a communication session is initiated between the intended recipient terminal and an application upon receipt of a response from the intended recipient terminal.

38. The method of claim 37, wherein the application is a VoiceXML browser.

39. The method of claim 37, wherein the application is a particular third party, a specific live person, a class of terminals, or a group of live agents.

40. A method of claim 37, wherein the event generator is located outside the communication system.

41. A method of claim 37, wherein the event message is sent to one intended recipient terminal connected to an external network.

42. A method of claim 37, wherein the event message is sent to many intended recipient terminals connected to an external network.
